(19) United States
(12) Patent Application Publication
(10) Pub. No.: US 2010/0283857 A1
(43) Pub. Date: Nov. 11, 2010

(54) EVENT BASED DYNAMIC CHANGE IN VIDEO QUALITY PARAMETERS OF NETWORK CAMERAS

(75) Inventor: Vivek Gopinath, Banglalore (IN)

Correspondence Address: HONEYWELL/HUSCH;Patent Services, 101 Columbia Road, P.O.Box 2245, Morrlstown, NJ, 07962, US

(73) Assignee: Honeywell International Inc., Morristown, NJ (US)

(21) Appl. No.: 12/435,828

(22) Filed: May 5, 2009

(51) Int. Cl. H04N 7/18

(52) U.S. Cl. 348/152; 348/E07.085

(57) ABSTRACT

A method and apparatus are provided for operating a security system. The method includes the steps of providing a network video camera coupled to the security system through a network, detecting a predetermined activity and increasing a video quality parameter of video transmitted between the network camera and the security system in response to the detected activity for a predetermined period of time.

### FIELD OF THE INVENTION

The Field of the Invention relates to security cameras and more particularly to the image quality of security cameras.

### BACKGROUND OF THE INVENTION

Video surveillance systems are generally known. Such systems are typically used in conjunction with security systems as a way for a small number of security personnel to monitor public areas or to detect intruders in secure areas who have bypassed convention deterrents such as locks or fences.

Typically a number of cameras are located throughout a monitored area. The video from each of the cameras is typically routed to a central location where a person may monitor images from each. Often the video from each of the cameras is saved for later analysis in the event of a security breach.

Many surveillance cameras are provided with motorized visual adjustment devices allowing tilt, pan and zoom to more closely observe an entire span of a secured area. Often the adjustment devices are programmed to continuously scan a secure area so that any intruder entering the area would always be present during some part of the scan.

While video surveillance systems work well, they are subject to a number of difficulties. For example, a break-in or other disturbance may be shown on the video from a camera, but security personnel may be distracted by some other event and not notice the incident or because of poor visual quality may assume that the intruder was an authorized associate.

Alternatively, a thief may spray paint a lens on a camera to block the collection of video from the camera. Even if security personnel notice the lack of video, they may assume that the camera has malfunctioned instead of being vandalized.

Moreover, even if the video of an intruder had been recorded, the camera may not have the video quality necessary to identify the intruder. Accordingly, a need exists for better methods of controlling the visual quality of surveillance cameras

### BRIEF DESCRIPTION OF THE DRAWINGS

FIG. 1 is a block diagram of a security system in accordance with an illustrated embodiment of the invention;

FIG. 2 is a flow chart of video processing that may be used by the system of FIG. 1; and

FIG. 3 depicts the use of the system of FIG. 1 with multiple cameras.

### DETAILED DESCRIPTION OF AN ILLUSTRATED EMBODIMENT

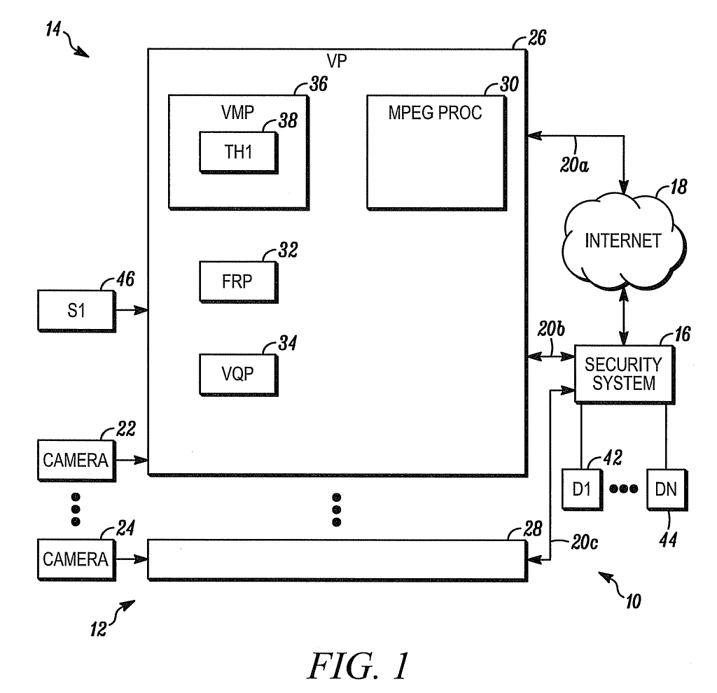

FIG. 1 is a block diagram of a security system 10 shown generally in accordance with an illustrated embodiment of the invention. Included within the system 10 may be a number of networked cameras 12, 14 connected to a central monitoring station 16 through an appropriate network connection 20a-c (e.g., Ethernet, Ethernet bridge, WAN, Internet, etc.).

The system 10 dynamically adjusts video quality parameters of video from the networked cameras 12, 14 to the central station 16. In the case of an analog camera a streamer/server may be used to first convert the analog output to a digital format. In either case, when significant change in a field of view (FOV) of a camera is observed, quality parameters of video are enhanced automatically. Similarly, if no activity is observed for a specified period of time, these parameters are reduced automatically.

The automatic change in video quality of the camera can be triggered in the case of detection of any of a number of different types of predetermined events (e.g., motion or activity in the FOV of the camera, detected camera sabotage, any I/O or network related event, alarms from algorithms running on the camera or on any camera integrated software, or activation signals from configured sensors or audio devices, etc.). When some event occurs in the FOV of the network camera, the system 10 automatically triggers the use of enhanced quality parameters in the camera to improve the video quality for some time after the event. This time period can be user configurable (e.g., 30 seconds, 1 minute, 2 minutes etc).

Each network camera 12, 14 may include a video detecting device 22, 24 and a respective video processing device 26, 28. The video processing device 26, 28 of each network camera 12, 14 functions to compress video for transmission through the network 20 to the central monitoring station 16. The video processing device 26, 28 and respective video detector 22, 24 may be separate (as shown in FIG. 1) or incorporated into the same enclosure.

Each video processor 26, 28 contains a frame rate processor 32 and a MPEG processor 30. The frame rate processor 32 receives frames at a fixed frame rate from the video detector 22, 24 and provides frames at a variable frame rate under control of a video quality processor 34 to the MPEG processor 30. The frame processor 32 may generate a variable frame rate by selecting source frames at a variable rate from the fixed frame rate of the video detector 22, 24 or by averaging pixel values across a variable number of frames.

Also included within the video processors 26, 28 is a video motion detector 36. The video motion detector 36 may function to detect motion within the fixed frame rate from the video detectors 22, 24 and provide a motion detected signal to the video quality processor 34.

The MPEG processor 30 compresses video received from the video detector 22, 24 for transmission through the network 20 to the central monitoring station 16. As is known, compression under MPEG (e.g., MPEG-4) includes the use of an I-frame, a P-frame and a B-frame. The I-frame is always the first frame of the set of frames including the I-frame, the P-frame and the B-frame. The value chosen for the size of the group of pictures (GOP) defines the frequency of occurrence of the I-frame.

Under illustrated embodiments, the size of the GOP of the MPEG processor 30 is dynamically adjusted by the video quality processor 34 to control a quality of the video delivered through the network 20 to the central monitoring station 16 based upon detection of at least one of a predetermined set of events. Other factors that may be dynamically adjusted in conjunction with the size of the GOP include a frame rate, a resolution and a bit rate.

As is known, resolution is based upon regional standards. For example, the common intermediate format (CIF) is 352 by 240 pixels in the horizontal and vertical directions in the U.S. and Japan under the NTSC standard and 352 by 288 in Europe under the PAL standard.

The acronym QCIF refers to one-quarter CIF or one-half the horizontal resolution and one-half the vertical resolution. For example, QCIF is 176 by 120 pixels in the U.S. and Japan under the NTSC standard and 176 by 144 in Europe under the PAL standard.

The acronym 4CIF refers to four times CIF or twice the horizontal resolution and twice the vertical resolution. For example, 4CIF is 704 by 480 pixels in the U.S. and Japan under the NTSC standard and 704 by 576 in Europe under the PAL standard.

The selected quality of video may be set to three different levels. In one example, the quality of video may be chosen from at least three levels including a low range, a high range and a middle range as shown below in Table I.

TABLE I

| Parameter | Low Range | High Range | Middle Range |
|---|---|---|---|
| Frame Rate | 1-5 fps | 25-30 fps | 10 fps |
| GOP | 30 | 5 | 15 |
| Bit Rate | FIXED | VARIABLE | FIXED |
| Resolution | QCIF | 4CIF | CIF |

The video quality parameters can each be independently varied according to the requirement of the user. The range of values for the major video parameters may be varied as shown in Table I.

For example, consider the situation where the frame rate is set to 10 frames per second (fps) normally (i.e., when the security system does not detect any activity). When an event occurs in the FOV of a camera, the camera frame rate may be automatically boosted to 25-30 fps for a predetermined time period. Similarly the GOP initially set to 30 by the operator may by automatically changed to 4-5 for the same time period so that the video quality can be improved, for a specific time period after the event detection in the Network camera. Resolution of a camera initially set to a QCIF resolution could be enhanced to 4CIF or CIF resolution as a result of the detected event and the bit rate which is generally set to FIXED by default could be set to VARIABLE for a specified time period after the event detection in FOV.

The automatic feature change can be implemented in any of a number of different situations. For example, the video motion processor 36 may monitor a pixel content of video from the image detectors 22, 24. If any motion or activity is detected in the FOV of the camera or if cameras sabotage is detected (e.g., changing the FOV, blinding, blurring of video images, etc.), the camera video parameters can be altered automatically. In this case, the video motion processor 36 may compare pixels of a current image with a reference image. If changes occur in pixel values that exceed some threshold 38, then the motion processor 36 may send a motion detected signal to a video quality processor 34. In response, the video quality processor 34 may determine a change of video quality required by the change and send appropriate signals to the video frame processor 32 and the MPEG processor 30. The signal from the video quality processor 34 to the frame rate processor 32 may specify a frame rate at which the frame processor 32 is to send frames to the MPEG processor 30. The signal from the video quality processor 34 to the MPEG processor 30 may specify a GOP, a resolution and a bit rate at which the MPEG processor 30 is to send video to the central monitoring station 16.

Similarly, if an I/O device (e.g., an IR motion detector 46) is interfaced to the camera 12, 14, and some event has been detected by the I/O device, the camera video parameters can be altered automatically via a signal sent directly to the video quality processor 34. Alternatively, if an external sensor or audio device 42, 44 interfaced to the camera 12, 14 through the central monitoring station 16 detects an event, the camera video parameters can be altered automatically. Similarly, an analytics algorithm running on the camera 12, 14 can detect an event and cause the alteration of the camera video parameters automatically.

The user can elect to have a combination or all of these quality features enhanced to a middle range or high range or degraded simultaneously from the high to the middle or low range to achieve a better quality video for a specified period of time, keeping in mind network bandwidth restrictions, if any. If the settings for frame rate, bit rate, GOP and resolution are set to default values like 10, fixed, 30 and QCIF respectively, and an event is detected, all these parameters can be changed simultaneously to 25, variable, 5 and CIF respectively to improve the overall video quality for the user configured time period post the event. Similarly, if there is no motion detected fro a considerable period of time after the parameters have been raised to higher values, then they can all be reduced automatically to lower values to save network bandwidth. Consequently, the frame rate of 25 fps can be decreased to 5/10 fps, the bit rate can be changed to Fixed from Variable, the GOP can be increased to 30 from 5 and the resolution can be decreased to QCIF from CIF.

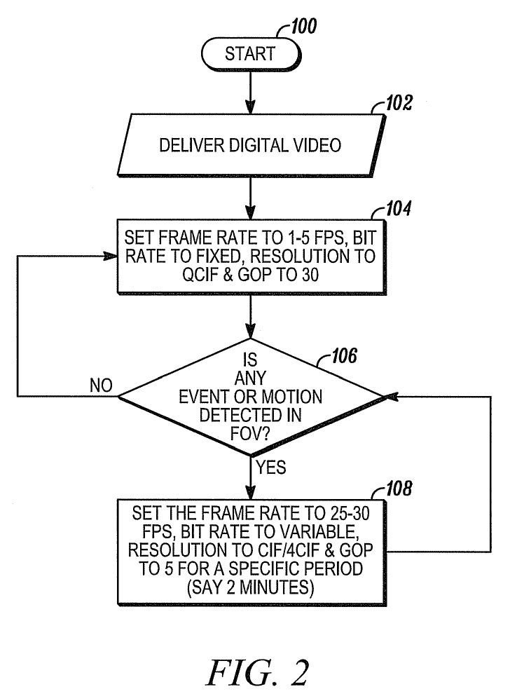

FIG. 2 depicts a flow chart that may be used in conjunction with the system 10. For example, after activation 100, the camera 12, 14 may begin delivering video 102 to the processing devices 26, 28. After initialization, the camera 12, 14 may set the frame rate to a value of 1-5 fps, the bit rate to fixed, the resolution to QCIF and the GOP to 30. The camera 12, 14 may then continually process video from the video detectors 22, 24 to detect 106 motion.

If motion is detect 106, the camera 12, 14 may set the frame rate to a value of 25-30 fps, the bit rate to variable, the resolution to CIF or 4CIF and the GOP to 4-5 for a predetermined period. The camera 12, 14 may then continually process video from the detectors 22, 24 to determine 106 if there is continued motion. If so, then the video quality may remain at a high level. If not, then the video quality may be set 104 to a lower level.

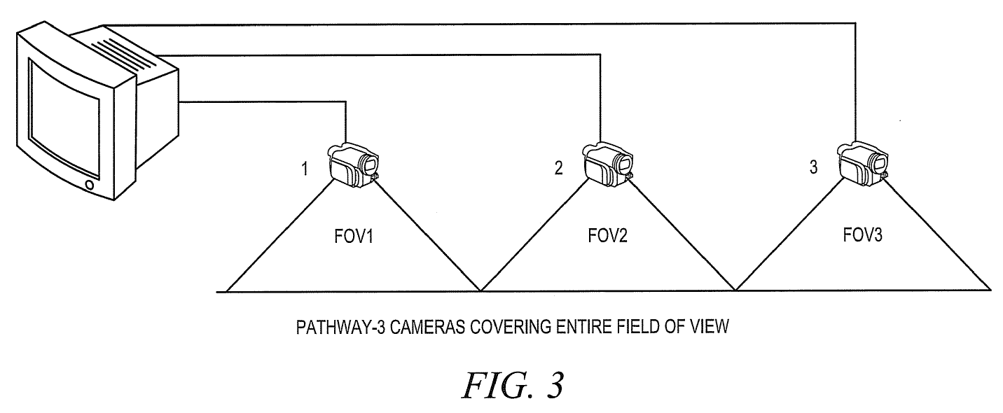

The concept of variable video quality can also be extended in the scenario where scene stitching is employed between multiple cameras placed next to each other (FIG. 3) to monitor a larger area. Assume camera 1, camera 2 and camera 3 scene stitched to cover a wider view as shown in FIG. 3. If a motion or any activity is detected by any of the 3 cameras, two actions will be performed. First, dynamic alteration of the video quality parameters is made based on the activity detected in the FOV of the camera. Assume motion is detected in the FOV of camera 2. The video parameters for camera 2 will be automatically enhanced in response to the motion detected in the FOV.

The second action may include sending an indication to the immediate neighboring cameras about possible motion or activity in their FOV. Assume camera 2 detects motion in its FOV. Camera 1 and camera 3 will receive an alarm or indication from camera 2 that a possible motion or activity will be soon be detected in their FOV. The video parameters for camera 1 and camera 3 could also be dynamically enhanced for a short period in expectation of an event in their fields of view.

While FIG. 1 shows the adjustment of video quality parameters within network cameras 12, 14, the concepts can also be extended to uncompressed video delivered to a local security panel (not shown). In this case, the adjustment of video quality parameters would be accomplished within the local security panel before transmission to a remote monitoring station.

The system 10 provides considerable advantage in that the network bandwidth can be optimized by the dynamic adjustment of camera quality parameters. Network bandwidth is optimized because it can be assumed that only a few network cameras at a time would operate with elevated video quality parameters. Since only a few network cameras at a time would operate with elevated video quality parameters the remaining network band that would otherwise be used for video transmission can be diverted to other uses.

A specific embodiment of method and apparatus for varying a video quality in a security system has been described for the purpose of illustrating the manner in which the invention is made and used. It should be understood that the implementation of other variations and modifications of the invention and its various aspects will be apparent to one skilled in the art, and that the invention is not limited by the specific embodiments described. Therefore, it is contemplated to cover the present invention and any and all modifications, variations, or equivalents that fall within the true spirit and scope of the basic underlying principles disclosed and claimed herein.

1. A method of operating a security system comprising:
providing a network video camera coupled to the security system through a network;
detecting a predetermined activity; and
increasing a video quality parameter of video transmitted between the network camera and the security system in response to the detected activity for a predetermined period of time.

2. The method of operating the security system as in claim 1 wherein the increased video quality parameter further comprises frame rate.

3. The method of operating the security system as in claim 1 wherein the increased video quality parameter further comprises a size of a group of frames between I-frames in an MPEG process.

4. The method of operating the security system as in claim 1 wherein the increased video quality parameter further comprises resolution.

5. The method of operating the security system as in claim 1 wherein the increased video quality parameter further comprises bit rate.

6. The method of operating the security system as in claim 1 wherein the predetermined event further comprises motion or activity in a field of view of the camera.

7. The method of operating the security system as in claim 1 wherein the predetermined event further comprises camera sabotage.

8. A security system comprising:
a network video camera coupled to the security system through a network;
means for detecting a predetermined activity; and
means for increasing a video quality parameter of video transmitted between the network camera and the security system in response to the detected activity for a predetermined period of time.

9. The security system as in claim 8 wherein the increased video quality parameter further comprises frame rate.

10. The security system as in claim 8 wherein the increased video quality parameter further comprises a size of a group of frames between I-frames in an MPEG process.

11. The security system as in claim 8 wherein the increased video quality parameter further comprises resolution.

12. The security system as in claim 8 wherein the increased video quality parameter further comprises bit rate.

13. The security system as in claim 8 wherein the predetermined event further comprises motion or activity in a field of view of the camera.

14. The security system as in claim 8 wherein the predetermined event further comprises camera sabotage.

15. A security system comprising:
a network video camera coupled to the security system through a network;
a predetermined activity detected by the security system; and
a video quality processor that increases a video quality parameter of video transmitted between the network camera and the security system in response to the detected activity for a predetermined period of time.

16. The security system as in claim 15 wherein the increased video quality parameter further comprises frame rate.

17. The security system as in claim 15 wherein the increased video quality parameter further comprises a size of a group of frames between I-frames in an MPEG process.

18. The security system as in claim 15 wherein the increased video quality parameter further comprises resolution.

19. The security system as in claim 15 wherein the increased video quality parameter further comprises bit rate.

20. The security system as in claim 15 wherein the predetermined event further comprises motion or activity in a field of view of the camera.

21. The security system as in claim 15 wherein the predetermined event further comprises camera sabotage.
